(19) United States
(12) Patent Application Publication
(10) Pub. No.: US 2024/0420655 A1
(43) Pub. Date: Dec. 19, 2024

(54) DISPLAY DEVICE

(71) Applicant: Shenzhen China Star Optoelectronics Semiconductor Display Technology Co., Ltd., Shenzhen (CN)

(72) Inventor: Wenwu LIAO, Shenzhen (CN)

(73) Assignee: Shenzhen China Star Optoelectronics Semiconductor Display Technology Co., Ltd., Shenzhen (CN)

(21) Appl. No.: 18/239,161

(22) Filed: Aug. 29, 2023

(30) Foreign Application Priority Data
Jun. 14, 2023 (CN) 202310704481.3

(51) Int. Cl. G09G 3/36; G06F 13/38

(52) U.S. Cl. CPC G09G 3/36; G06F 13/382; G09G 2310/08; G09G 2370/08

(57) ABSTRACT

The display device includes a control module, a display module, and a functional module. The control module includes a system board, an EDP connector, and a timing driving chip. The EDP connector is connected to the system board and the timing chip. The display module is connected to the timing driving chip. The functional module, connected to the timing driving chip, is configured to detect a touch action in response to the second type signal. The EDP connector is configured to convert a display signal provided by the system board into a first type signal. The timing driving chip is configured to transmit the first type signal to the display module. The EDP connector is configured to convert a touch signal provided by the system board into a second type signal, and the timing driving chip is configured to transmit the second type signal to the functional module.

### CROSS REFERENCE TO RELATED APPLICATION

This application claims priority to Chinese Application No. 202310704481.3, filed on Jun. 14, 2023. The entire disclosure of the above application is incorporated herein by reference.

### FIELD OF THE INVENTION

The present application relates to the field of display technology, specifically to a display device.

### BACKGROUND

With the continuous development of display technology, the functions of display devices are also increasing. For example, in order to meet the needs of human-computer interaction, functional modules will be added to the display device to make the display device have both display function and touch function.

The system-on-chip (SOC) in the display device needs to output the display signal and touch signal to the corresponding data interfaces at the same time, and increase the amount of data processing. The data interface currently used to receive the system-on-chip output signal is a V-by-One (VBO) interface which is poor compatibility to the functional module, and has a disadvantage of low transmission rate. Therefore, this problem needs to be solved to meet market demand.

### SUMMARY

The present disclosure provides a display device, which can effectively solve the problem of poor compatibility between the data interface and the functional module of the conventional display device, and improve the transmission rate of the data interface.

According to a first aspect of the present disclosure, a display device includes a control module, a display module, and a functional module. The control module includes a system board, an Embedded DisplayPort (EDP) connector, and a timing driving chip. The EDP connector is connected to the system board and the timing chip. The display module is connected to the timing driving chip. The functional module, connected to the timing driving chip, is configured to detect a touch action in response to the second type signal. The EDP connector is configured to convert a display signal provided by the system board into a first type signal. The timing driving chip is configured to transmit the first type signal to the display module. The EDP connector is configured to convert a touch signal provided by the system board into a second type signal, and the timing driving chip is configured to transmit the second type signal to the functional module.

Optionally, the EDP connector includes a conversion chip, input pins disposed on a first side of the conversion chip and connected to the system board, and output pins disposed on a second side of the conversion chip.

Optionally, the output pins include a set of first data signal pins, a set of second data signal pins, a set of third data signal pins and a set of fourth data signal pins. All of the first data signal pins, second data signal pins, third data signal pins, and fourth data signal pins are configured to output the first type signal.

Optionally, the output pin further includes a first touch pin and a second touch pin, and all of the first touch pin and second touch pin are configured to output the second type signal.

Optionally, the second type signal comprises a Universal Serial Bus (USB) touch signal and a Universal Asynchronous Receiver/Transmitter (UART) touch signal.

Optionally, the display device further includes a conversion circuit coupling the EDP connector, the timing driving chip, the first touch pin, and the second touch pin. The conversion circuit is configured to switch the second type signal received by the timing driving chip to the USB touch signal or the UART touch signal.

Optionally, the output pin further includes a switching pin coupled to the conversion circuit and configured to switch a first state and a second state of the conversion circuit. When the conversion circuit is at the first state, the second type signal received by the timing driving chip is the USB touch signal. When the conversion circuit is at the second state, the second type signal received by the timing driving chip is the UART touch signal.

Optionally, the conversion circuit includes a jumper resistor that comprises a first resistor, a second resistor, a third resistor, a fourth resistor, a fifth resistor and a sixth resistor. The state of the conversion circuit is at the first state when each of the first resistor, the third resistor and the fifth resistor is conducted, and the state of the conversion circuit is at the second state when each of the second resistor, the fourth resistor and the sixth resistor is conducted.

Optionally, the display module includes a source driver chip, a gate driver chip, and a liquid crystal display panel which is driven by the source driver chip and the gate driver chip in response to the first type signal received by the display module.

Optionally, the functional module includes a touch electrode and a processing circuit which controls the touch electrode to detect whether there is the touch action in response to the second type signal received by the functional module.

According to a second aspect of the present disclosure, a display device includes an Embedded DisplayPort (EDP) connector, a timing driving chip, a display module, and a functional module. The EDP connector is configured to convert a display signal and a touch signal generated from signal sources into a first type signal and a second type signal, respectively. The timing driving chip, connected to the EDP connector, is configured to process and output the first type signal and the second type signal. The display module, connected to the timing driving chip, is configured to drive the display device to display images in response to the first type signal. The functional module, connected to the timing driving chip, is configured to detect a touch action in response to the second type signal.

Optionally, the EDP connector includes a conversion chip, input pins disposed on a first side of the conversion chip and connected to the system board, and output pins disposed on a second side of the conversion chip.

Optionally, the output pins include a set of first data signal pins, a set of second data signal pins, a set of third data signal pins and a set of fourth data signal pins. All of the first data signal pins, second data signal pins, third data signal pins, and fourth data signal pins are configured to output the first type signal.

Optionally, the output pin further includes a first touch pin and a second touch pin, and all of the first touch pin and second touch pin are configured to output the second type signal.

Optionally, the second type signal comprises a Universal Serial Bus (USB) touch signal and a Universal Asynchronous Receiver/Transmitter (UART) touch signal.

Optionally, the display device further includes a conversion circuit coupling the EDP connector, the timing driving chip, the first touch pin, and the second touch pin. The conversion circuit is configured to switch the second type signal received by the timing driving chip to the USB touch signal or the UART touch signal.

Optionally, the output pin further includes a switching pin coupled to the conversion circuit and configured to switch a first state and a second state of the conversion circuit. When the conversion circuit is at the first state, the second type signal received by the timing driving chip is the USB touch signal. When the conversion circuit is at the second state, the second type signal received by the timing driving chip is the UART touch signal.

Optionally, the conversion circuit includes a jumper resistor that comprises a first resistor, a second resistor, a third resistor, a fourth resistor, a fifth resistor and a sixth resistor. The state of the conversion circuit is at the first state when each of the first resistor, the third resistor and the fifth resistor is conducted, and the state of the conversion circuit is at the second state when each of the second resistor, the fourth resistor and the sixth resistor is conducted.

Optionally, the display module includes a source driver chip, a gate driver chip, and a liquid crystal display panel which is driven by the source driver chip and the gate driver chip in response to the first type signal received by the display module.

Optionally, the functional module includes a touch electrode and a processing circuit which controls the touch electrode to detect whether there is the touch action in response to the second type signal received by the functional module.

According to the present disclosure, a display device includes a control module, a display module, and a functional module. The control module includes a system board, an Embedded DisplayPort (EDP) connector, and a timing driving chip. The EDP connector is connected to the system board and the timing chip. The display module is connected to the timing driving chip. The functional module, connected to the timing driving chip, is configured to detect a touch action in response to the second type signal. The EDP connector is configured to convert a display signal provided by the system board into a first type signal. The timing driving chip is configured to transmit the first type signal to the display module. The EDP connector is configured to convert a touch signal provided by the system board into a second type signal, and the timing driving chip is configured to transmit the second type signal to the functional module. The data interface of the display device provided by the present disclosure has high compatibility with the functional module, and the transmission rate is high.

### BRIEF DESCRIPTION OF THE DRAWINGS

In order to more clearly illustrate the technical solution in the embodiment of the present disclosure, the following will be a brief introduction to the drawings required in the description of the embodiment. Obviously, the drawings described below are only some embodiments of the present disclosure, for those skilled in the art, without the premise of creative labor, may also obtain other drawings according to these drawings.

FIG. 1 is a block diagram of a display device according to an embodiment of the present disclosure.

FIG. 2 is a schematic diagram of the EDP connector according to an embodiment of the present disclosure.

FIG. 3 is a circuit diagram of the conversion circuit according to an embodiment of the present disclosure.

### DETAILED DESCRIPTION OF PREFERRED EMBODIMENTS

To help a person skilled in the art better understand the solutions of the present disclosure, the following clearly and completely describes the technical solutions in the embodiments of the present invention with reference to the accompanying drawings in the embodiments of the present invention. Apparently, the described embodiments are a part rather than all of the embodiments of the present invention. All other embodiments obtained by a person of ordinary skill in the art based on the embodiments of the present invention without creative efforts shall fall within the protection scope of the present disclosure.

The term “first”, “second” are for illustrative purposes only and are not to be construed as indicating or imposing a relative importance or implicitly indicating the number of technical features indicated. Thus, a feature that limited by “first”, “second” may expressly or implicitly include at least one of the features.

In the description of the present disclosure, the meaning of “plural” is two or more, unless otherwise specifically defined.

Throughout the specification and claims, when it is described that an element is “connected” to another element, the element may be “directly connected” to the other element, or “electrically connected” to the other element through a third element.

Furthermore, the term “comprising” will be understood as meaning the inclusion of elements but not the exclusion of any other elements, unless explicitly described to the contrary.

The following disclosure provides many different embodiments or examples to implement different structures of the present disclosure. In order to simplify the disclosure of the present disclosure, the components and settings of specific examples are described below. They are for example purposes only and are not intended to limit this application. Further, the present disclosure may repeat reference numbers and/or reference letters in different examples, such duplication is for the purpose of simplification and clarity, and does not by itself indicate the relationship between the various embodiments and/or settings discussed. Further, the present disclosure provides various examples of specific processes and materials, but those of ordinary skill in the art may be aware of the application of other processes and/or the use of other materials. The following are described in detail, it should be noted that the order of description of the following embodiments is not used as a qualification for the preferred order of embodiments.

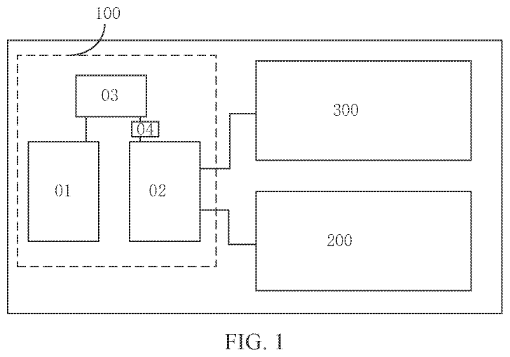

FIG. 1 is a block diagram of a display device according to an embodiment of the present disclosure. The present disclosure provides a display device for solving the problem of poor compatibility of the data interface and the functional module in the existing display device.

The display device comprises a control module 100, a display module 200 and a functional module 300. The control module 100 is disposed on a non-display side of the display module 200, and the functional module 300 is disposed on a display side of the display module 200.

The control module 100 includes a system board 01, a timing driving chip 02 (T-con), and an Embedded Display Port (EDP) connector 03 which is electrically connected to the system board 01 and the timing driving chip 02. The display module 200 is electrically connected to the timing driving chip 02. The functional module 300 is electrically connected with the timing driving chip 02.

The EDP connector 03 is configured to convert the display signal provided by the system board 01 into a first type signal, and transmit the first type signal to the timing driving chip 02. The timing driving chip 02 is used to transmit the first type signal to the display module 200. The EDP connector 03 is further configured to convert the functional signal provided by the system board 01 into a second type signal, and transmit the second type signal to the timing driving chip 02. The timing driving chip 02 is also used to transmit the second type signal to the functional module 300.

Optionally, the function signal is a touch signal. The function module 300 as a touch module is used to perform touch functions, to achieve user interaction with the display device. The present disclosure does not restrict the touch mode of the touch module, such as capacitive touch, electromagnetic touch, etc.

In the display device provided by the present disclosure, the EDP interface in the EDP connector 03 in terms of transmission efficiency, the single channel (Lane) transmission rate can reach 8.1 Gbps, and the VBO single-channel transmission rate is only 2.97 Gbps. Therefore, the display device provided by the present disclosure by using an EDP connector 03 having an EDP interface, can greatly improve the transmission rate of the data interface.

The EDP connector 03 is capable of converting the display signal provided by the system board 01 into the first type signal and transmitting the first type signal to the timing driving chip 02. The EDP connector 03 is also capable of converting the touch signal provided by the system board 01 into the second type signal, and transmitting the second type signal to the timing driving chip 02. The display module 200 and the function module 300 electrically connected to the timing driving chip 02 are capable of receiving the first type signal and the second type signal through the timing driving chip 02, respectively. Thus, the EDP connector 03 can be adapted to the display module 200 and the function module 300 at the same time, improving the problem of poor compatibility between the data interface and the functional module 300 in the existing connector.

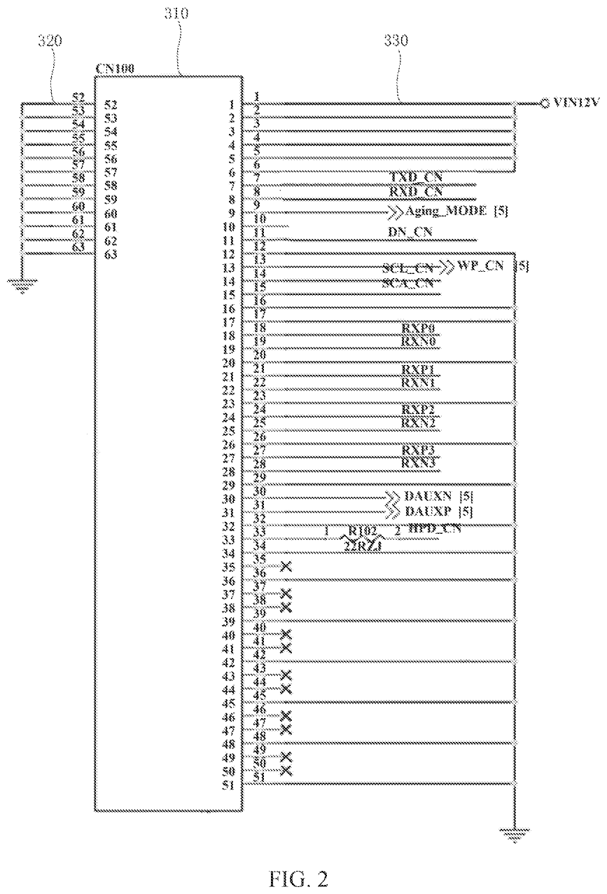

FIG. 2 is a schematic diagram of the EDP connector 03 according to an embodiment of the present disclosure. With reference to FIG. 1 and FIG. 2, the EDP connector 03 includes a conversion chip 310, an input pin 320 and an output pin 330. The input pin 320 is disposed on a first side of the conversion chip 310. The input pin 320 is electrically connected to the system board 01. The output pin 330 is disposed on a second side of the conversion chip 310, where the first side and the second side are different sides of the conversion chip 310.

In some embodiments of the present disclosure, the output pin 330 comprises a set of first data signal pins, a set of second data signal pins, a set of third data signal pins and a set of fourth data signal pins. All of the first data signal pins, the second data signal pins, the third data signal pins, the fourth data signal pins output the first type signal.

Referring to FIG. 2, the set of first data signal pins include an RXP0 pin and an RXN0 pin. The set of second data signal pins include an RXP1 pin and an RXN1pin. The set of third data signal pins include an RXP2 pin and an RXN2 pin. The set of fourth data signal pins includes an RXP3 pin and an RXN3 pin. Compared with the connector corresponding to the VBO interface needing eight groups of data signal pins, the EDP connector 03 of the present disclosure provides four groups of data signal pin groups. Accordingly, the display device provided by the present disclosure can effectively save the number of wires and space costs.

In some embodiments of the present disclosure, the output pin 330 further comprises a first touch pin and a second touch pin. The first touch pin and the second touch pin output the second type signal. Specifically, referring to FIG. 2, the first touch pin is a TXD_CN pin, and the second touch pin is a RXD_CN pin.

In some embodiments of the present disclosure, the second type signal comprises a USB touch signal and a UART touch signal. Optionally, the first touch pin is used to output a Universal Serial Bus (USB) touch signal, and the second touch pin is used to output a Universal Asynchronous Receiver/Transmitter (UART) touch signal.

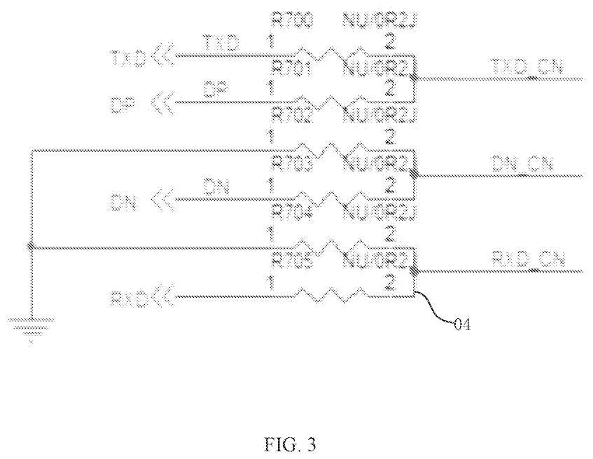

FIG. 3 is a circuit diagram of the conversion circuit 04 according to an embodiment of the present disclosure. Referring to FIG. 1 through FIG. 3, the display device further comprises a conversion circuit 04 connected to the EDP connector 03 and the timing driving chip 02. The conversion circuit 04 is electrically connected to the first touch pin and the second touch pin, and configured to switch the second type signal received by the timing driving chip 02 to the USB touch signal or the UART touch signal.

In some embodiments of the present disclosure, the output pin 330 further comprises a switching pin electrically connected to the conversion circuit 04. The switching pin is used to control the state of the conversion circuit 04. The state of the conversion circuit 04 includes a first state and a second state. When the conversion circuit 04 is at the first state, the second type signal received by the timing driving chip 02 is the USB touch signal. When the conversion circuit 04 is at a second state, the second type signal received by the timing driving chip 02 is the UART touch signal.

In some embodiments of the present disclosure, the conversion circuit 04 comprises a jumper resistor that includes a first resistor, a second resistor, a third resistor, a fourth resistor, a fifth resistor and a sixth resistor. The state of the conversion circuit 04 is at the first state when each of the first resistor, the third resistor and the fifth resistor is conducted, and the state of the conversion circuit is at the second state when each of the second resistor, the fourth resistor and the sixth resistor is conducted. Further, the jumper resistor is detachably connected with the conversion circuit 04.

Referring to FIG. 3, the first resistor is R700, the second resistor is R701, the third resistor is R702, the fourth resistor is R703, the fifth resistor is R704, and the sixth resistor is R705. When each of the first resistor, the third resistor and the fifth resistor is conducted, the USB touch signal output by the first touch pin is smoothly output to the timing driving chip 02 through the conversion circuit 04. When each of the second resistor, the fourth resistor and the sixth resistor is conducted, the UART touch signal output by the second touch pin is smoothly output to the timing driving chip 02 through the conversion circuit 04. Thus, the present disclosure can use the EDP connector 03 to realize the transmission of touch signals, thereby reducing the number of touch signal lines and simplifying the system design.

In some embodiments of the present disclosure, the display module 200 comprises a liquid crystal display panel, a source driver chip and a gate driver chip. The source driver chip and the gate driver chip drive the liquid crystal display panel display according to the first type signal received by the display module 200.

Further, the resolution of the liquid crystal display panel is greater than or equal to 4 K (3840*2160). Specifically, since the EDP connector 03 includes an EDP interface with higher transmission rate, the display device provided by the present disclosure can be adapted to an ultra-high resolution liquid crystal display panel.

In some embodiments of the present disclosure, the functional module 300 comprises a touch electrode and a processing circuit. The processing circuit controls the touch electrode to detect whether there is a touch action according to the second type signal received by the functional module 300.

In summary, the present disclosure provides a display device. The display device includes a control module, a display module, and a functional module. The control module includes a system board, an Embedded DisplayPort (EDP) connector, and a timing driving chip. The EDP connector is connected to the system board and the timing chip. The display module is connected to the timing driving chip. The functional module, connected to the timing driving chip, is configured to detect a touch action in response to the second type signal. The EDP connector is configured to convert a display signal provided by the system board into a first type signal. The timing driving chip is configured to transmit the first type signal to the display module. The EDP connector is configured to convert a touch signal provided by the system board into a second type signal, and the timing driving chip is configured to transmit the second type signal to the functional module. The data interface and the functional module in the display device provided by the present disclosure have high compatibility, high transmission rate, and small occupied space.

The above is a display device provided by an embodiment of the present disclosure is described in detail, and a specific example is applied herein to explain the principle and embodiment of the present disclosure, and the description of the above embodiment is only used to help understand the method of the present disclosure and its core ideas. At the same time, for those skilled in the art, according to the idea of the present disclosure, there will be changes in the specific embodiment and the scope of application, in summary, the content of this specification should not be understood as a restriction on the present disclosure.

1. A display device comprises:
a control module comprising a system board, an Embedded DisplayPort (EDP) connector, and a timing driving chip, wherein the EDP connector is connected to the system board and the timing chip;
a display module, connected to the timing driving chip; and
a functional module, connected to the timing driving chip, configured to detect a touch action in response to the second type signal,
wherein the EDP connector is configured to convert a display signal provided by the system board into a first type signal, and the timing driving chip is configured to transmit the first type signal to the display module, and
wherein the EDP connector is configured to convert a touch signal provided by the system board into a second type signal, and the timing driving chip is configured to transmit the second type signal to the functional module,
wherein the display module comprises a liquid crystal display panel, and a resolution of the liquid crystal display panel is greater than or equal to 3840*2160,
wherein the output pin further comprises a first touch pin and a second touch pin, and all of the first touch pin and second touch pin are configured to output the second type signal,
wherein the second type signal comprises a Universal Serial Bus (USB) touch signal and a Universal Asynchronous Receiver/Transmitter (UART) touch signal.

2. The display device according to claim 1, wherein the EDP connector comprises:
a conversion chip;
input pins, disposed on a first side of the conversion chip and connected to the system board; and
output pins, disposed on a second side of the conversion chip.

3. The display device according to claim 2, wherein the output pins comprise a set of first data signal pins, a set of second data signal pins, a set of third data signal pins and a set of fourth data signal pins, and all of the first data signal pins, second data signal pins, third data signal pins, and fourth data signal pins are configured to output the first type signal.

4-5. (canceled)

6. The display device according to claim 1, further comprising a conversion circuit, coupling the EDP connector, the timing driving chip, the first touch pin, and the second touch pin, and configured to switch the second type signal received by the timing driving chip to the USB touch signal or the UART touch signal.

7. The display device according to claim 6, wherein the output pin further comprises a switching pin coupled to the conversion circuit and configured to switch a first state and a second state of the conversion circuit, when the conversion circuit is at the first state, the second type signal received by the timing driving chip is the USB touch signal; when the conversion circuit is at the second state, the second type signal received by the timing driving chip is the UART touch signal.

8. The display device according to claim 7, wherein the conversion circuit comprises a jumper resistor that comprises a first resistor, a second resistor, a third resistor, a fourth resistor, a fifth resistor and a sixth resistor; the state of the conversion circuit is at the first state when each of the first resistor, the third resistor and the fifth resistor is conducted, and the state of the conversion circuit is at the second state when each of the second resistor, the fourth resistor and the sixth resistor is conducted.

9. The display device according to claim 1, wherein the display module comprises:
a source driver chip;
a gate driver chip; and
a liquid crystal display panel, driven by the source driver chip and the gate driver chip in response to the first type signal received by the display module.

10. The display device according to claim 1, wherein the functional module comprises a touch electrode and a processing circuit which controls the touch electrode to detect whether there is the touch action in response to the second type signal received by the functional module.

11. A display device comprises:
an Embedded Display Port (EDP) connector, configured to convert a display signal and a touch signal generated from signal sources into a first type signal and a second type signal, respectively;
a timing driving chip, connected to the EDP connector, and configured to process and output the first type signal and the second type signal;
a display module, connected to the timing driving chip, configured to drive the display device to display images in response to the first type signal; and
a functional module, connected to the timing driving chip, configured to detect a touch action in response to the second type signal,
wherein the display module comprises a liquid crystal display panel, and a resolution of the liquid crystal display panel is greater than or equal to 3840*2160,
wherein the output pin further comprises a first touch pin and a second touch pin, and all of the first touch pin and second touch pin are configured to output the second type signal,
wherein the second type signal comprises a Universal Serial Bus (USB) touch signal and a Universal Asynchronous Receiver/Transmitter (UART) touch signal.

12. The display device according to claim 11, wherein the EDP connector comprises:
a conversion chip;
input pins, disposed on a first side of the conversion chip; and
output pins, disposed on a second side of the conversion chip.

13. The display device according to claim 12, wherein the output pins comprise a set of first data signal pins, a set of second data signal pins, a set of third data signal pins and a set of fourth data signal pins, and all of the first data signal pins, second data signal pins, third data signal pins, and fourth data signal pins are configured to output the first type signal.

14-15. (canceled)

16. The display device according to claim 11, further comprising a conversion circuit, coupling the EDP connector, the timing driving chip, the first touch pin, and the second touch pin, and configured to switch the second type signal received by the timing driving chip to the USB touch signal or the UART touch signal.

17. The display device according to claim 16, wherein the output pin further comprises a switching pin coupled to the conversion circuit and configured to switch a first state and a second state of the conversion circuit, when the conversion circuit is at the first state, the second type signal received by the timing driving chip is the USB touch signal; when the conversion circuit is at the second state, the second type signal received by the timing driving chip is the UART touch signal.

18. The display device according to claim 17, wherein the conversion circuit comprises a jumper resistor that comprises a first resistor, a second resistor, a third resistor, a fourth resistor, a fifth resistor and a sixth resistor; the state of the conversion circuit is at the first state when each of the first resistor, the third resistor and the fifth resistor is conducted, and the state of the conversion circuit is at the second state when each of the second resistor, the fourth resistor and the sixth resistor is conducted.

19. The display device according to claim 11, wherein the display module comprises:
a source driver chip;
a gate driver chip; and
a liquid crystal display panel, driven by the source driver chip and the gate driver chip in response to the first type signal received by the display module.

20. The display device according to claim 11, wherein the functional module comprises a touch electrode and a processing circuit which controls the touch electrode to detect whether there is a touch action in response to the second type signal received by the functional module.
